(19) United States
(12) Patent Application Publication
(10) Pub. No.: US 2011/0092864 A1
(43) Pub. Date: Apr. 21, 2011

(54) SYSTEM AND METHOD FOR AUTOMATIC CPR

(75) Inventors: Pierre H. Woerlee, Valkenswaard (NL); Igor W. F. Paulussen, Nuenen (NL); Thomas J. De Hoog, Eindhoven (NL)

(73) Assignee: KONINKLIJKE PHILIPS ELECTRONICS N.V., Eindhoven (NL)

(21) Appl. No.: 12/809,112

(22) PCT Filed: Dec. 15, 2008
(86) PCT No.: PCT/IB2008/055296

§ 371 Date: Dec. 10, 2010

Related U.S. Application Data
(60) Provisional application No. 61/014,810, filed on Dec. 19, 2007.

(51) Int. Cl. A61H 31/00

(52) U.S. Cl. 601/41

(57) ABSTRACT

A method for applying a plurality of compressive forces to a thorax of a patient, measuring a displacement corresponding to each of the plurality of compressive forces, and determining properties of the thorax based on the compressive forces and the displacement. A system having a force applying device applying compressive forces to a thorax of a patient, a measurement device measuring a displacement of the thorax corresponding to each of the compressive forces, and a control device determining properties of the thorax based on the displacements of the thorax corresponding to each of the compressive forces.

### FIELD OF THE INVENTION

The present invention relates generally to a system and method for automatically performing cardio pulmonary resuscitation (CPR). More specifically, visco-elastic properties of the thorax are calculated in order to determine an appropriate compressive force to be applied to a patient.

### BACKGROUND

Cardiac arrest is one of the most frequent causes of death in the modern world. Cardio pulmonary resuscitation (“CPR”) is the preferred method for temporary initial treatment of a victim who has suffered cardiac arrest until professional care is possible. CPR involves compression of the victim's chest in order to induce blood flow through the body.

Manual CPR is intense and physically exhausting. Few people are capable of performing good quality CPR for prolonged periods, and poor quality CPR is detrimental to the health of the victim. Further, it is difficult to properly perform CPR during transportation in an ambulance.

Devices exist to mechanically automate the performance of CPR. However, these devices typically suffer from a number of difficulties. These include lack of personalization in devices that use a fixed force, lethal organ damage caused by devices that failed to properly limit applied force, and results that are poorer than those achieved by manual CPR.

### SUMMARY OF THE INVENTION

The present invention relates to a method for applying a plurality of compressive forces to a thorax of a patient, measuring a displacement corresponding to each of the plurality of compressive forces, and determining properties of the thorax based on the compressive forces and the displacement.

The present invention relates to a system having a force applying device applying compressive forces to a thorax of a patient, a measurement device measuring a displacement of the thorax corresponding to each of the compressive forces, and a control device determining properties of the thorax based on the displacements of the thorax corresponding to each of the compressive forces.

### DESCRIPTION OF THE DRAWINGS

FIG. 1 shows an exemplary embodiment of a method for automatically performing CPR according to the present invention.

FIG. 2 shows an exemplary embodiment of a system for automatically performing CPR according to the present invention.

FIG. 3 shows displacement-force relationships for chest compressions based on measured data for a set of victims.

FIG. 4 shows estimated compression forces required for three groups of victims.

FIG. 5 shows a cross-sectional schematic illustration of a mathematical visco-elastic model of the thorax of a patient.

FIG. 6 shows plots of displacement and velocity for a three-level force pulse against time for an average person based on the model of FIG. 5.

FIG. 7 shows a feedback-based learning system for mechanically performing CPR according to the present invention.

### DETAILED DESCRIPTION

The exemplary embodiments of the present invention may be further understood with reference to the following description and the appended drawings, wherein like elements are referred to with the same reference numerals. The exemplary embodiments of the present invention describe a system and method for automatically performing CPR in a manner that adjusts to each individual patient.

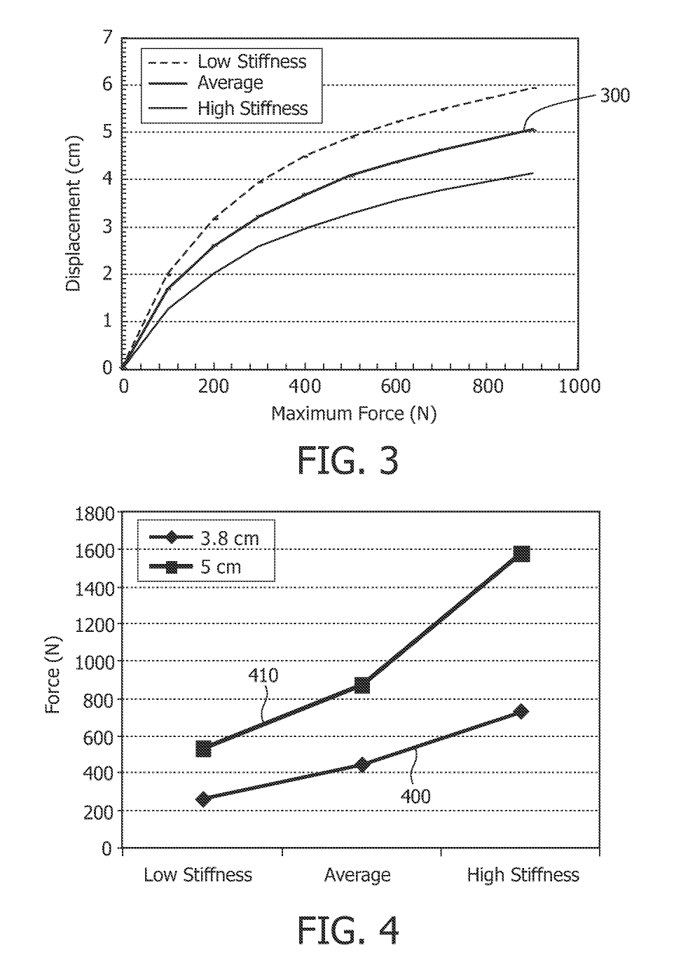

The American Heart Association (“AHA”) and the European Resuscitation Council (“ERC”) recommend that CPR is performed most effectively in cycles of 30 compressions followed by two ventilations. It is recommended that compressions be performed at the rate of 90 per minute. Compressions should typically be to a depth of 3.8 to 5 centimeters (1.5 to 2 inches); the force needed to achieve such compressions varies greatly among different patients, typically in the range of 250 to 1600 Newtons. The maximum force required for a specific victim generally cannot be estimated from the size of the victims and may change during the resuscitation. Hence, the maximum force needed to reach a pre-determined compression depth must be determined individually and may need to be adapted during resuscitation. FIG. 3 illustrates the displacement-force relationships for a set of victims with different degrees of chest stiffness. That is, FIG. 3 shows the amount of force in Newtons (x-axis) required for different chest compression depths in centimeters (y-axis) for the target group of victims. The heavy solid line 300 shows the average person in this group of victims.

FIG. 4 more generally illustrates estimates of the force (y-axis) required to achieve 3.8 centimeter displacements (line 400) and 5 centimeter displacements (line 410) for three categories of patients (e.g., low-stiffness, average and high-stiffness). The exemplary graph shows that the amount of force required to be applied to any one patient (e.g., low-stiffness, average or high-stiffness) may vary greatly depending on the compression depth and that the amount of force required to be applied to different patients covers a wide range. In addition, the potentially high required force, coupled with the rapid optimal pace of compressions, results in the difficulty of performing high-quality of CPR for extended periods of time.

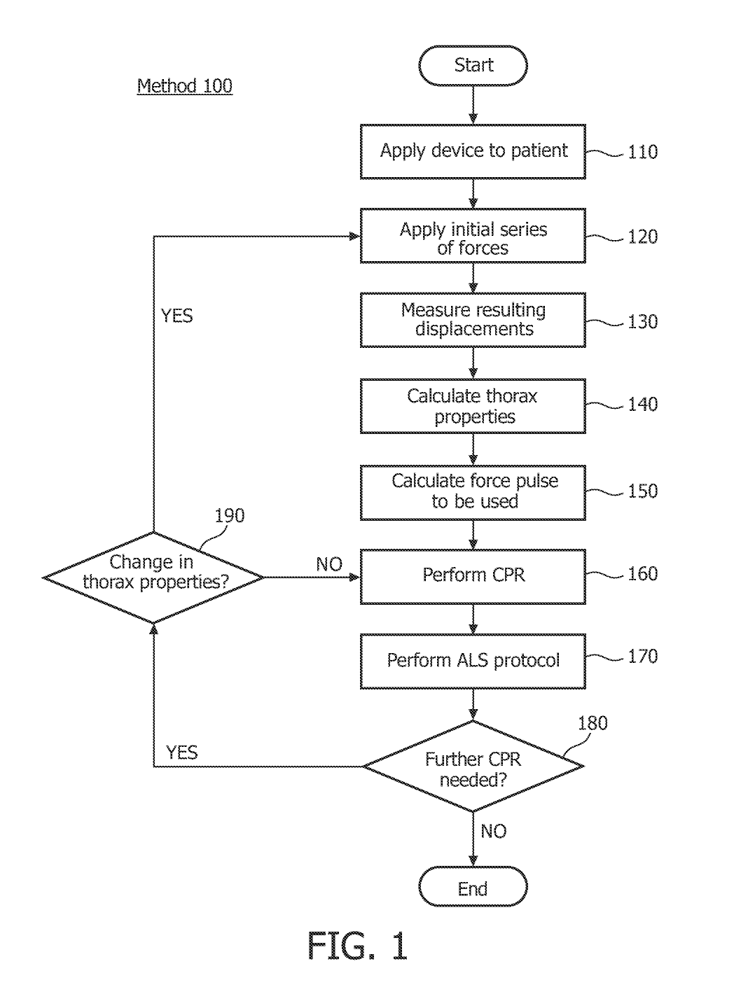

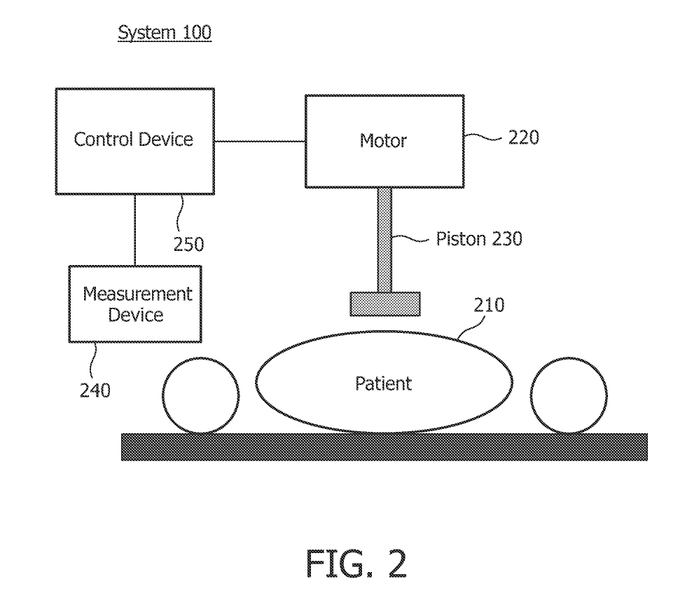

FIG. 1 illustrates an exemplary method 100 for the implementation of the present invention. In step 110, a device for applying a known compressive force to the thorax is applied to a patient. The device may be, for example, the exemplary system 200 described below with reference to FIG. 2. The specific steps involved in connecting the device depend on the structural details of the device and will not be discussed in detail here.

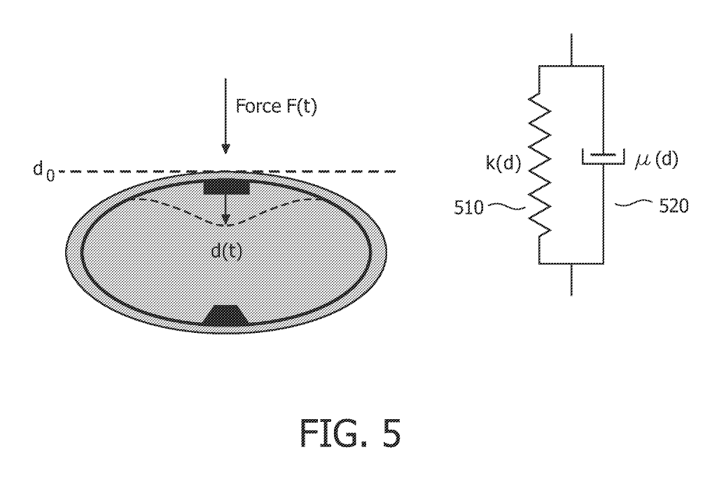

In step 120, the device applies an initial series of forces to the thorax. A human thorax may be modeled by a combination of mechanical spring(s) 510 and damper(s) 520, as illustrated in FIG. 5 (e.g., a visco-elastic model of a thorax). The spring constant and the damping constant are strongly dependent on the compression depth (e.g., they are non-linear). The exemplary embodiments of the present invention may use a model of the thorax to determine the appropriate force to be applied to the patient. In addition, the exemplary embodiments may also provide for an optimal chest compression pulse shape versus time to be applied to each patient.

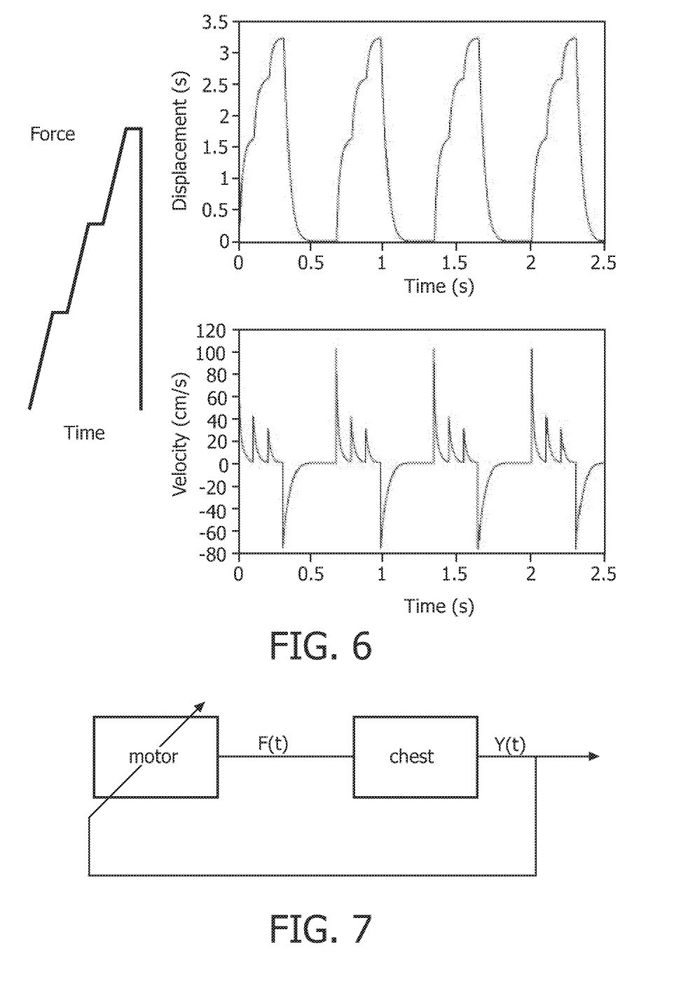

Thus, in one exemplary embodiment implementing step 120, the forces may be applied in a pattern of a staircase function as shown in FIG. 6. That is, FIG. 6 illustrates plots of displacement and velocity against time for the given step force function. The maximum force to be applied in step 120 may be limited to a preset maximum value in order to prevent injury to patients who may be especially susceptible. The number of steps in the staircase may also be varied depending on the desired accuracy and number of parameters to be used in creating the model. The above sequence provides an estimate of the maximum force allowed for the victim at the specific time of measurement.

As the series of forces are applied by the device, the patient's chest displacement is measured in step 130. Those skilled in the art will understand that the displacement measurement may be accomplished in a variety of manners. For example, measurement may be accomplished by using light reflected from a simple pattern or a ruler-like pattern, a potentiometer, an accelerometer, using CPR device characteristics, measuring the number of motor revolutions, etc. Methods that provide an absolute position of the chest surface are preferred because the chest shape may change during CPR.

In step 140, the known applied forces and measured velocities and displacements (typically as shown in FIG. 5) are used to calculate physical properties of the thorax. The spring constant may be estimated on the basis of the final displacement and applied force according to Hooke's Law. Subsequently, from the velocity of displacement under various applied loading, the damping constant may also be estimated. By fitting the depth-dependent spring and damper data to two polynomials, one for the spring and one for the damper, a simple and valid (up to the maximum applied force) general model for displacement versus force may be obtained. The polynomials to be used have a limited number of terms. For the spring constant, an nth order polynomial in d (the displacement) can be used; the order n is typically 3 to 5. As an example, Fₛ(d(t))=kₛ(d)*d(t)=(a₀+a₁*d(t)+a₂*d(t)²+a₃*d(t)³)*d(t). Here, d(t) is equal to the difference between the actual chest position at time t and its position d₀ when the chest is fully relaxed. Note that d₀ may vary slowly during CPR. For the damping, a lower order (n=1 or 2) polynomial is sufficient, e.g. F_{d}=(b₀+b₁*d(t))*v(t) where v(t) is the velocity of the chest at time t (i.e., the time derivative of d(t)). From this model, the force pulse to be used in order to achieve the desired displacement of 3.8 to 5 centimeters is determined in step 150.

Once the model has been determined in step 140 and the force pulse to be used has been determined in step 150, CPR can be administered automatically in step 160. As described above, the CPR cycle recommended by the AHA and the ECR is 30 compressions at the rate of 90 per minute, followed by two ventilations. Thus, after determining the correct model for the individual patient, CPR may be automatically performed using the correct amount of force for the individual patient.

After the performance of the recommended cycle of compressions, the Advanced Life Support (“ALS”) protocol is administered, if available, in step 170. Steps of the ALS protocol may include checking rhythm, defibrillation, administration of drugs, etc. After administration of the ALS protocol, further CPR may be required; in step 180, it is determined whether this is the case. If no further CPR is required (e.g., because of the return of spontaneous circulation after the ALS protocol), the CPR procedure is terminated and the method ends. However, if further CPR is required, the method proceeds to step 190.

During the compressions, the mechanical properties of the thorax may change (e.g., if the thorax becomes less stiff, if ribs break, etc.). Furthermore, the position of the chest at full relaxation, d₀may change; typically, it moves inwards in the direction of the spine. Changes in the measured displacement and d₀ from that anticipated by the model determined in step 140 are monitored during the performance of CPR. Monitoring of d₀ requires a position measurement against a fixed reference point. In step 190, it is determined whether change in the displacement has exceeded a predetermined threshold, indicating that thorax properties have changed. For example, the force being applied based on the originally calculated model may be designed to create a compression of 3.8 to 5 centimeters. However, the device may constantly monitor the actual compression using, for example, the methods described above. If the actual compression exceeds a threshold value (e.g., δ₁=10% of the maximum depth, i.e. 0.5 centimeters), it may be determined that the mechanical properties of the thorax have changed and therefore a new model needs to be calculated for the patient. When d₀ has changed by more than a specified distance δ₂ (e.g., 0.25 centimeters), the model and force pulse must be recalculated. In general, it is not recommended to increase the maximum compression depth above a certain limit (compared to the starting d₀ position, i.e., 5 centimeters+δ₁), as sever thorax and organ damage can occur. This implies that the compression pulse shape has changed. It should be noted that the device may be set to monitor a series of compressions rather than any one single compression measurement in order to eliminate an aberrant measurement from requiring a new model calculation.

If it is determined that the properties of the thorax have changed, the method returns to step 120, where the process of determining a model for the patient is repeated. If thorax properties have not changed, the method continues at step 160. In step 160, CPR is continued for a certain number of compressions (e.g., 200); thereafter, ALS protocol is performed again. If CPR continues to be required, the above procedures repeat. If no CPR is needed (e.g., because of the return of spontaneous circulation after the ALS protocol), the CPR procedure is stopped.

In another exemplary embodiment of the present invention, a single continuous compression may be applied to the thorax of the patient. Model parameters (e.g., the spring constant and the damping constant of the thorax) may then be determined directly using brute-force fitting. Using such an approach, several iterations may be required (each at an increasing fixed force pulse) until a desirable compression depth has been obtained.

FIG. 7 illustrates another exemplary method of the present invention. In such an embodiment, an input (i.e. the force F(t)) is applied to the chest of the patient and the output (i.e. the displacement Y(t)) is measured. The force (i.e., the feed forward component of the control loop) is then adjusted so that the desired output displacement is reached. This may be performed as a repetitive process, and may be performed for many types of pressure actuators. By using this type of feedback, non-idealities of the actuator and the thorax can be corrected for during the chest compressions.

FIG. 2 illustrates an exemplary system 200 for the mechanical performance of CPR on a patient 210 (shown in cross-section). The exemplary system 200 comprises a motor 220 driving a piston 230, a measurement device 240, and a control device 250. Those of skill in the art will understand that the control device 250 may be any device that is capable of performing the calculations required and of communicating with the motor 220 and the measurement device 240 (e.g., a mobile computer, a PDA, a servo controller, etc.).

As described above, the system 200 is positioned such that the motor 220 can drive the piston 230 to apply compressive force to the thorax of the patient 210 (step 110 of exemplary method 100). The control device 250 directs the motor 220 to perform the initial set of compressions (step 120). The measurement device 240 measures the resulting displacements (step 130). Based on the applied forces, the control device 250 determines the visco-elastic properties of the thorax of the patient 210 (step 140) and the appropriate force to use to achieve the desired compression (step 150). The control device 250 then instructs the motor 220 to perform compressions as described above (step 160), pausing for ventilation to take place.

The measurement device 240 continues to monitor the actual displacement (preferably from a fixed reference point) resulting from the force applied by the motor 220 and the piston 230, communicating with the control device 250 so that it can determine whether the properties of the thorax have changed sufficiently that the displacement has varied beyond a certain threshold (step 170). In this case, thorax properties have to be evaluated again (step 190).

The exemplary system 200 has been described specifically with reference to the use of a motor 220 and piston 230 to apply compressive force to the thorax of the patient 210. However, those of skill in the art will understand that these structures are only exemplary, and that other structures that are capable of providing similar force (e.g., a band that is contracted around the thorax to provide compression, etc.) may be used without departing from the broader scope of the present invention. For example, the invention may also be applied to manual CPR when a pad comprising a force and displacement sensor is used to guide CPR. Further, as previously described, the measurement device 240 may be, for example, a device that records light reflected from a simple pattern or a ruler-like pattern, a potentiometer, an accelerometer, positions and revolutions of a motor, angular sensors, etc. However, those of skill in the art will understand that these are only examples and that measurement device 240 may be any other means capable of measuring of the thorax and/or compression of the thorax of the patient 210.

By the application of the above-described exemplary embodiments of the present invention, automatic CPR may be administered in a manner that more closely approximates manual CPR.

It will be apparent to those skilled in the art that various modifications may be made to the present invention, without departing from the spirit or scope of the invention. Thus, it is intended that the present invention cover the modifications and variations of this invention provided they come within the scope of the appended claims and their equivalents.

1-10. (canceled)

11. A system, comprising:
a force applying device for applying compressive forces to a thorax of a patient;
a measurement device for measuring a displacement of the thorax corresponding to each of the compressive forces; and
a control device for determining properties of the thorax based on the displacements of the thorax corresponding to each of the compressive forces,
wherein the control device is further adapted for determining an optimal compressive force to achieve an optimal displacement based on the properties.

12. (canceled)

13. The system of claim 11, wherein the control device is further adapted for instructing the force applying device to apply the optimal compressive force to the thorax.

14. The system of claim 13, wherein the measurement device is further adapted for measuring further displacements corresponding to the optimal compressive forces and the control device determines whether the further displacements exceed a threshold.

15. The system of claim 14, wherein the control device is further adapted for calculating further properties of the thorax when the further displacements exceed the threshold.

16. The system of claim 11, wherein the optimal compressive force corresponds to an optimal displacement of 3.8-5 centimeters.

17. The system of claim 11, wherein the properties include a spring constant of the thorax and a damping constant of the thorax.

18. The system of claim 11, wherein the measurement device is one of an accelerometer, a potentiometer, an optical measuring component, an LVDT device, a reflected light, one or more angular sensors, one or more magnetic sensors, and a device for measuring a number of revolutions of a motor.

19. The system of claim 11, wherein the force applying device includes one of a piston and a compressing belt.

20-21. (canceled)
